(19) United States
(12) Patent Application Publication
(10) Pub. No.: US 2012/0016972 A1
(43) Pub. Date: Jan. 19, 2012

(54) SNMP AGENT DEVICE AND CONFIGURATION UNDO METHOD

(75) Inventor: Junichi Tamura, Kanagawa (JP)

(73) Assignee: Fujitsu Telecom Networks Limited, Kanagawa (JP)

(21) Appl. No.: 13/181,146

(22) Filed: Jul. 12, 2011

(30) Foreign Application Priority Data
Jul. 13, 2010 (JP) 2010-158510

(51) Int. Cl. G06F 15/177

(52) U.S. Cl. 709/220

(57) ABSTRACT

An SNMP agent device includes: a receiving unit configured to receive an SNMP configuration command from a manager device; a configuration processing unit configured to update, when the configuration command designates management information and a configuration value, the management information in the agent device by the configuration value; and a configuration history storage unit configured to store the configuration command, mapping the configuration to a pre-update value of the management information. When the configuration command designates undo, the configuration processing unit performs an undo process of returning the management information updated by a past configuration command to the value occurring before the update.

### BACKGROUND OF THE INVENTION

1. Field of the Invention

The present invention relates to a data processing technology and, more particularly, to a technology of managing the operating status of devices using the simple network management protocol (SNMP).

2. Description of the Related Art

SNMP management systems adapted to manage the operating status of devices are built. We propose in patent document No. 1 a technology capable of reading a detailed cause of an error even in the case where there are a plurality of SNMP managers and requests from a plurality of managers are in confliction in an SNMP agent.

[patent document No. 1] JP 2004-302532

### SUMMARY OF THE INVENTION

An SNMP manager may update the management information base (MIB) of an SNMP agent by issuing a setRequest message (hereinafter, referred to as “configuration command”) to the SNMP agent. When it is necessary to cancel a configuration command issued in the past and return the status of the MIB to original (e.g., when the content of the configuration command is in error), the SNMP manager needs to issue a new configuration command designating the value in the MIB occurring before the update. We have thought that this increases the load on the maintenance operator of the SNMP management system and involves a risk in that the status of the MIB cannot be returned to original unless the maintenance operator knows the value of the MIB occurring before the update.

The present invention is produced based on our awareness of the issue described above and a primary purpose thereof is to provide a technology of improving the convenience in canceling a configuration command issued by an SNMP manager to an SNMP agent.

The SNMP agent device according to one embodiment of the present invention comprises: a receiving unit configured to receive an SNMP configuration command from a manager device; a configuration processing unit configured to update, when the configuration command designates management information and a configuration value, the management information in the agent device by the configuration value; and a configuration history storage unit configured to store the configuration command, mapping the configuration to a pre-update value of the management information. When the configuration command designates undo, the configuration processing unit performs an undo process of returning the management information updated by a past configuration command to the value occurring before the update.

Another embodiment of the present invention relates to a configuration undo method. The configuration undo method is executed by an SNMP agent device, and comprises: receiving an SNMP configuration command from a manager device; updating, when the configuration command designates management information and a configuration value, the management information in the agent device by the configuration value; storing the configuration command, mapping the configuration to a pre-update value of the management information; and performing, when the configuration command designates undo, an undo process of returning the management information updated by a past configuration command to the value occurring before the update.

Optional combinations of the aforementioned constituting elements, and implementations of the invention in the form of apparatuses, methods, systems, programs, and recording mediums having embodied thereon programs may also be practiced as additional modes of the present invention.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 shows the configuration of an SNMP management system according to an embodiment of the present invention;

FIG. 2 is a block diagram showing the functional configuration of the agent device of FIG. 1;

FIG. 3A shows the configuration of the history table stored in the configuration history storage unit;

FIG. 3B schematically shows a pointer stored in the configuration history storage unit;

FIG. 4 shows the configuration of OID's in the MIB;

FIG. 5 is a flowchart showing the operation of the agent device;

FIG. 6 is a flowchart showing the history retrieval process in S14 of FIG. 5 in further detail;

FIG. 7 is a flowchart showing the management information updating process in S16 of FIG. 5 in further detail;

FIG. 8 is a flowchart showing the command-based undo process in S40 of FIG. 7 in further detail; and

FIG. 9 is a flowchart showing the object-based undo process in S42 of FIG. 7 in further detail.

### DETAILED DESCRIPTION OF THE INVENTION

The invention will now be described by reference to the preferred embodiments. This does not intend to limit the scope of the present invention, but to exemplify the invention.

In this embodiment, a technology is proposed for implementing an undo process in an SNMP agent. When the SNMP agent according to the embodiment receives an undo request from an SNMP manager, the SNMP agent returns the MIB updated by a configuration command (setRequest) received from the SNMP manager to the state occurring before the update. An undo request does not need to identify the state of MIB occurring after the undo process. The MIB is automatically returned to the state that dates back before the update, based on the history of configuration commands received in the past. In this way, configuration commands issued from the SNMP manager to the SNMP client in the past can be canceled more conveniently.

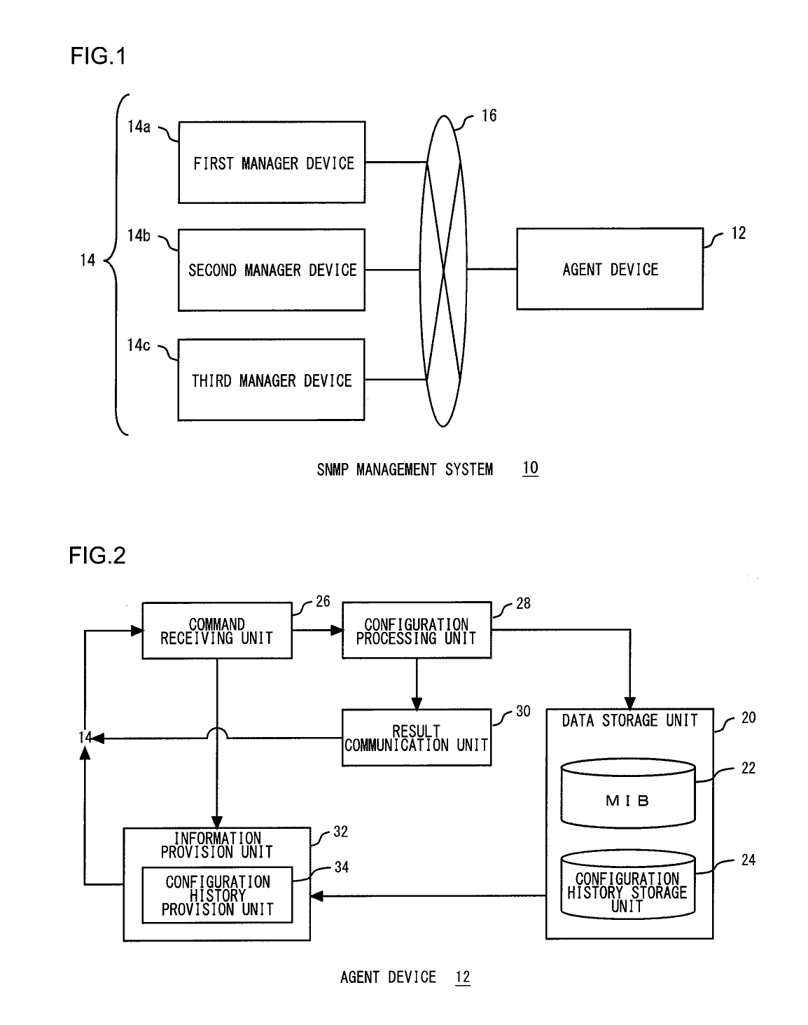

FIG. 1 shows the configuration of an SNMP management system according to an embodiment of the present invention. The SNMP management system 10 comprises a first manager device 14a, a second manager device 14b, a third manager device 14c, which are generically referred to as manager devices 14, and an agent device 12. The agent device 12 and the manager devices 14 are connected to each other via a communication network 16 LAN, WAN, and the Internet, which includes a known communication means.

The agent device is an information processing device monitored in the SNMP management system 10. For example, the agent device 12 may be a communication control device such as a switch or a router. SNMP agent software may be installed in the agent device 12 or hardware such as electronic circuits providing the same function as the software may be installed in the agent device 12. The manager device 14 is an information processing device that monitors the agent device 12 according to SNMP. The manager device 14 may be a PC or a server in which the SNMP manager software is installed.

FIG. 2 is a block diagram showing the functional configuration of the agent device 12 of FIG. 1. The agent device 12 comprises a data storage unit 20, which is a storage area for data, a command receiving unit 26, a configuration processing unit 28, a result communication unit 30, and an information provision unit 32 which are a data processing unit for performing data processing.

The blocks shown in the block diagram are implemented by hardware such as CPU or memory of a computer, devices such as HDD, electronic circuits, and mechanical devices, and by software such as a computer program. FIG. 2 depicts functional blocks implemented by the cooperation of hardware and software. Therefore, it will be obvious to those skilled in the art that the functional blocks may be implemented in a variety of manners by a combination of hardware and software. The functional blocks of FIG. 2 may be stored in a removable recording medium as program modules and installed in the agent device 12. The functions of the functional blocks related to related to the data processing unit of FIG. 1 may be implemented by being loaded into the memory of the agent device 12 as necessary and executed by the CPU.

The data storage unit 20 includes an MIB 22 and a configuration history storage unit 24. The MIB 22 is a database for storing various management information related to agent device 12 that can be referred to and configured by the management device 14. Each item of management information is assigned an object identifier (hereinafter, referred to as “OID”) and is uniquely identified by the OID.

The configuration history storage unit 24 stores a history of configuration commands received from the manager device 14. More specifically, the unit 24 stores the content of the configuration command received from the manager device 14 in the past with pre-update value of the management information updated by that configuration command.

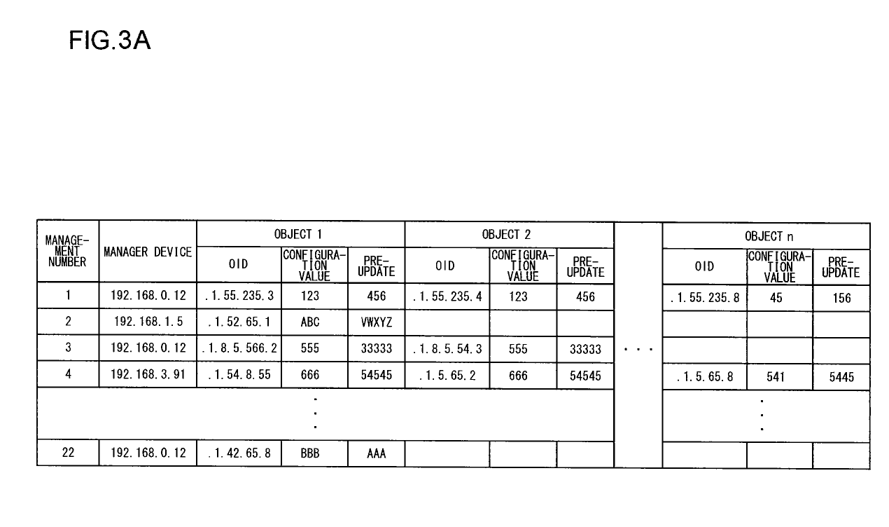

FIG. 3A shows the configuration of the history table stored in the configuration history storage unit 24. The history table stores records in units of configuration commands. Each record contains a management number for uniquely identifying the record, and the ID (in this case, the IP address) of the manager device 14 originating the configuration command. The record also contains information related to one or more object designated by a configuration command (combination of OID and configuration value). The management number is incremented in the ascending order of the time and date of receipt. The object information may include the OID of the target of configuration, the configuration value designated by the manager device 14, i.e., the updated configuration value and the configuration value occurring before the update.

FIG. 3B schematically shows a pointer stored in the configuration history storage unit 24. The management number pointer field contains the management number of the configuration command received last from the manager device 14, i.e., the latest configuration command. The object number of pointer field contains the number for the object located at the end in the configuration command designated by the management number pointer, i.e., the object configured last.

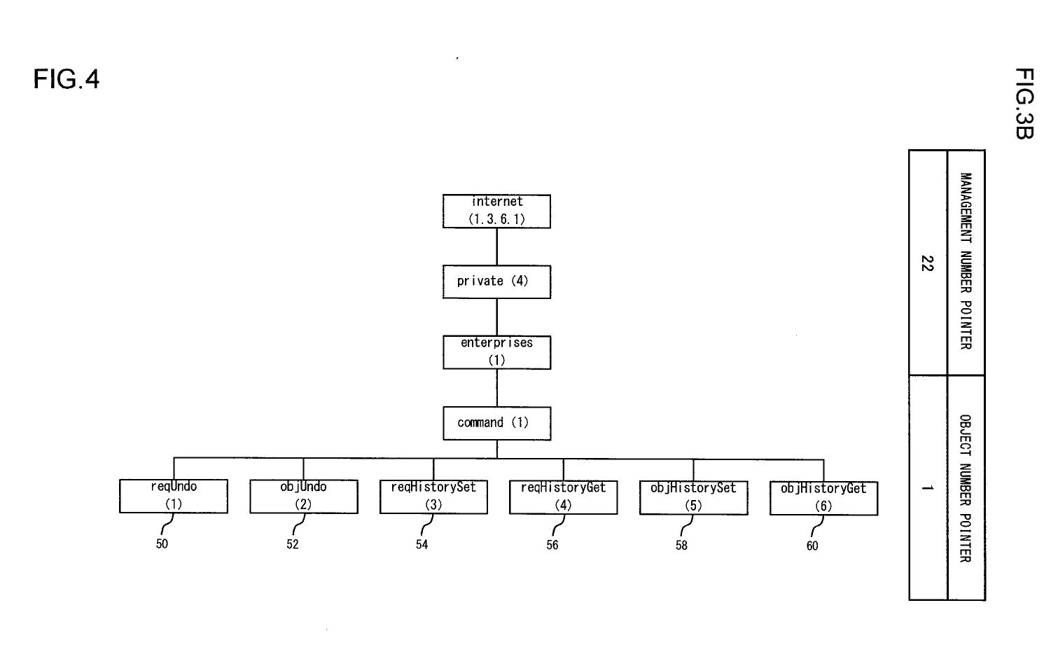

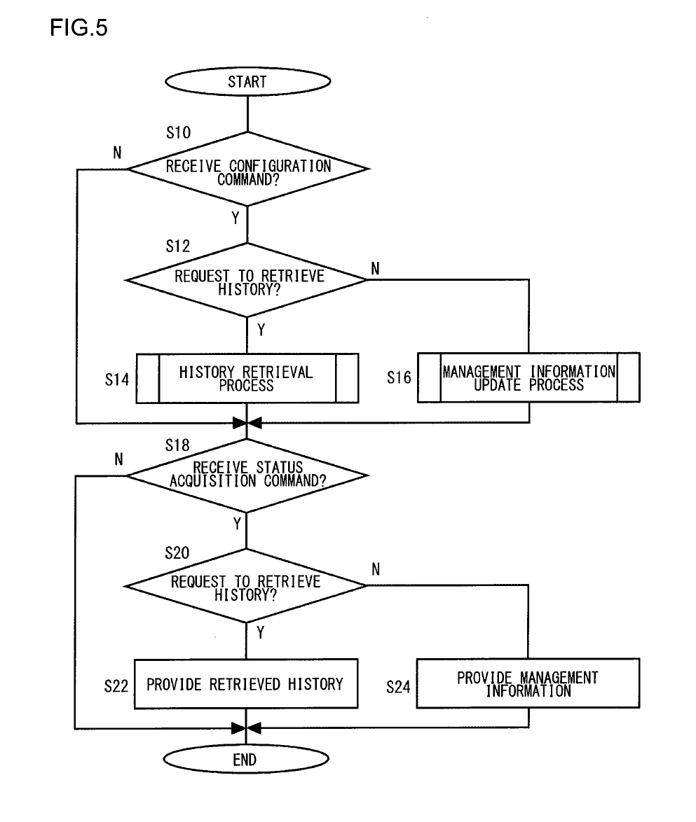

FIG. 4 shows the configuration of OID's in the MIB 22. FIG. 4 shows a part of the information stored in the MIB 22 and shows how OIDs are assigned to six types of commands unique to the embodiment. Of course, the MIB 22 also stores various recorded information (not shown) (hereinafter, simply referred to as “management information”) other than the commands.

A command-based undo command 50 is used to designate an undo process in units of configuration commands received from the manager device 14, i.e., in units of records in the history table. The command-based undo command 50 is uniquely identified by the OID “1, 3, 6, 1, 4, 1, 1, 1”. An object-based undo command 52 is used to designate an undo process in units of objects in the configuration command, i.e., in units of management information updated by the configuration command.

A command-based history retrieval command 54 is used to designate a history retrieval process to retrieve a history in units of past configuration commands. A command-based history provision command 56 is used to designate a history provision process to provide a history in units of past configuration commands. An object-based history retrieval command 58 is used to designate a history retrieval process to retrieve a history in units of objects related to past configuration commands. An object-based history provision command 60 is used to designate a history provision process to provide a history in units of objects related to past configuration commands.

As described later, the OID of the command-based undo command 50, the object-based undo command 52, the command-based history retrieval command 54, and the object-based history retrieval command 58 is designated in the configuration command from the manager device 14. The OID of the command-based history provision command 56 and the object-based history provision command 60 is designated in getRequest (hereinafter, also referred to as “status acquisition command”) from the manager device 14.

The command-based history retrieval command 54 and the command-based history provision command 56 are used collectively by the manager device 14 to acquire a history of configuration commands. More specifically, the manager device 14 causes the agent device 12 to retrieve a past configuration command data by issuing a configuration command designating the command-based history retrieval command 54. The manager device 14 causes the agent device 12 to provide the past configuration command data by issuing a status acquisition command designating the command-based history provision command 56.

Similarly, the object-based history retrieval command 58 and the object-based history provision command 60 are used collectively by the manager device 14 to acquire a history of configuration commands. More specifically, the manager device 14 causes the agent device 12 to retrieve past object data by issuing a configuration command designating the object-based history retrieval command 58. The manager device 14 causes the agent device 12 to provide the past object data by issuing a status acquisition command designating the object-based history provision command 60.

Referring back to FIG. 2, the command receiving unit 26 receives an SNMP message from the manager device 14. In this embodiment, it is assumed that the unit 26 receives a configuration command or a status acquisition command. The result communication unit 30 transmits the result of processing the configuration command to the manager device 14 as SNMP getResponse data.

When a configuration command is acquired by the command receiving unit 26, the configuration processing unit 28 executes the configuration process related to the object included in the configuration command and updates the data storage unit 20 as appropriate. When a single configuration command includes a plurality of objects, the configuration processing unit 28 processes the objects sequentially, starting with the object designated at the beginning. When the configuration command indicates an undo request, the management information in the MIB 22 is restored to the status occurring before the update by updating the management information in the MIB 22 with the pre-update value stored in the history table of the configuration history storage unit 24.

When a status acquisition command is acquired by the command receiving unit 26, the information provision unit 32 acquires the data related to the management information designated by the status acquisition command from the data storage unit 20 and sends the data to the manager device 14 as SNMP getResponse data. The information provision unit 32 includes a configuration history provision unit 34. When the status acquisition command designates a history provision process, the configuration history provision unit 34 sends the information related to the configuration command received in the past to the manager device 14 as getResponse data defined in SNMP.

A description will be given of a typical example of an SNMP message received by the agent device 12 from the manager device 14 and the content of process performed for the message.

setRequest (OID=[OID of management information], Value=integer, 123) (Example 1)

Example 1 pertains to a normal configuration command. The configuration processing unit 28 updates the management information in the MIB 22 corresponding to the designated OID with the designated integer value “123”.

setRequest (OID=[OID of the command-based undo command 50], Value=integer, 0) (Example 2)

setRequest (OID=[OID of the command-based undo command 50], Value=integer, 3) (Example 3)

Example 2 and Example 3 are configuration commands requesting an undo process in units of configuration commands. The parameter of the command-based undo command 50 designates the number of undos. In Example 3, three undo processes are requested. Examine 2 pertains to a case where the number of undos is not explicitly designated by the manager device 14 and is equivalent to the designating “1” as the number of undos. The configuration processing unit 28 refers to the history table in the configuration history storage unit 24, identifies as many configuration commands as indicated by the number of undos, starting with the latest configuration command, and executes an undo process in units of configuration commands sequentially, starting with the latest command.

setRequest (OID=[OID of the object-based undo command 52], Value=integer, 0] (Example 4)

setRequest (OID=[OID of the object-based undo command 52], Value=integer, 4) (Example 5)

Example 4 and Example 5 are configuration commands requesting an undo process in units of objects. The parameter of the object-based undo command 52 designates the number of undos. In Example 5, four undo processes are requested. Examine 4 pertains to a case where the number of undos is not explicitly designated by the manager device 14 and is equivalent to the designating “1” as the number of undos. The configuration processing unit 28 refers to the history table in the configuration history storage unit 24 and identifies as many objects as indicated by the number of undos, starting with the last object in the latest configuration command. The configuration processing unit 28 sequentially undos the management information indicated the objects (i.e., management information updated in the past) in units of objects (i.e., in units of management information), starting with the latest command.

getRequest (OID=[OID of management information], Value=integer, 0) (Example6)

Example 6 pertains to a normal status acquisition command. The information provision unit 32 sends getResponse data including the value (in this case, the integer value) of the management information with the designated OID to the manager device 14.

setRequest (OID=[ID of the command-based history retrieval command 54], Value=integer, 5) (Example 7)

Example 7 pertains to a configuration command requesting a history retrieval process in units of configuration commands. The parameter of the command-based history retrieval command 54 designates how far in the past the configuration command to be retrieved was issued. In Example 7, retrieval of the fifth last configuration command issued is requested. The configuration processing unit 28 refers to the history table in the configuration history storage unit 24, identifies the configuration command that goes back from the latest configuration command by the parameter value, and stores the content of the identified command in a predetermined buffer of the data storage unit 20 as past configuration command data. The past configuration command data indicates the content of configuration of objects included in a single configuration command record stored in the history table. For example, the past configuration command data may be character string data containing “OID designated in object 1, configuration value designated in object 1, OID designated in object 2, configuration value designated in object 2, . . . ”.

getRequest (OID=[ID of the command-based history provision command 56], Value=OCTET STRING, null) (Example 8)

Example 8 pertains to a status acquisition command requesting provision of a history in units of configuration commands. “OCTET STRING” is set in the parameter of the command-based history provision command 56 to acquire variable-length history information. The configuration history provision unit 34 acquires the past configuration command data retrieved by the command-based history retrieval command 54 and stored in a predetermined buffer in the data storage unit 20. The configuration history provision unit 34 sends the getResponse data including the past configuration command data to the manager device 14.

In one variation of Example 7 and Example 8, the configuration processing unit 28 may include in the past configuration command data the pre-update value of the management information designated in the object, in place of or in addition to the configuration value designated in the object. The configuration history provision unit 34 may provide the manager device 14 with the pre-update value of the management information designated in the object in place of or in addition to the configuration value designated in the object. In this variation, the status of the management information occurring before the update is presented to the maintenance operator so that the maintenance operator can decide how an undo process should be performed.

setRequest (OID=[ID of the object-based history retrieval command 58], Value=integer, 5) (Example 9)

Example 9 pertains to a configuration command requesting a history retrieval process in units of objects. The parameter of the object-based history retrieval command 58 designates how far in the past the object to be retrieved was configured, starting with the object configured last. In Example 9, retrieval of the fifth last object is requested. The configuration processing unit 28 refers to the history table in the configuration history storage unit 24, identifies the object that goes back from the object configured last in the latest configuration command by the parameter value, and stores the content of the identified object in a predetermined buffer of the data storage unit 20 as past object data. The past object data indicates the content of configuration in a single object stored in the history table. For example, the past object data may be character string data containing “OID designated in a specific object and configuration value designated in the specific object”.

getRequest (OID=[ID of the object-based history provision command 60], Value=OCTET STRING, null) (Equation 10)

Example 10 pertains to a status acquisition command requesting provision of a history in units of objects. “OCTET STRING” is set in the parameter of the object-based history provision command 60 to acquire variable-length history information. The configuration history provision unit 34 acquires the past object data retrieved by the object-based history retrieval command 58 and stored in a predetermined buffer in the data storage unit 20. The configuration history provision unit 34 sends the getResponse data including the past object data to the manager device 14.

In one variation of Example 9 and Example 10, the configuration processing unit 28 may include in the past object data the pre-update value of the management information designated in the object, in place of or in addition to the configuration value designated in the object. The past object data provided by the configuration history provision unit 34 to the manager device 14 may include the pre-update value of the management information designated in the object in place of or in addition to the configuration value designated in the object. In this variation, the status of the management information occurring before the update is presented to the maintenance operator so that the maintenance operator can decide how an undo process should be performed.

As already described in part, a plurality of objects (combinations of a plurality of types of OID and configuration values) may be designated in a single configuration command. For example, a single configuration command may include a mixture of an undo request and a request for configuring management information. Alternatively, a plurality of types of undo requests may be mixed. The configuration processing unit 28 sequentially reflects the requests in the MIB 22, starting with the object at the beginning and ending with the last object. Conversely, an undo process is started with the last object in the past configuration command and ends with the object at the beginning.

A description will now be given of the operation performed in the configuration described above.

FIG. 5 is a flowchart showing the operation of the agent device 12. When a configuration command is received from the manager device 14 (Y in S10), the command receiving unit 26 sends the command to the configuration processing unit 28. The configuration processing unit 28 identifies the OID designated in the configuration command (refers to the MIB 22). When the OID of a history retrieval request (the command-based history retrieval command 54 or the object-based history retrieval command 58) is designated (Y in S12), the configuration processing unit 28 performs a history retrieval process (S14). When the OID of a history retrieval request is not designated, and when the OID of the management information, the command-based undo command 50, or the object-based undo command 52 is designated (N in S12), the configuration processing unit executes the process of updating the management information (S16). When a configuration command is not received (N in S10), S12-S16 are skipped.

When a status acquisition command is received from the manager device 14 (Y in S18), the command receiving unit 26 sends the status acquisition command to the information provision unit 32. The information provision unit 32 identifies the OID designated in the status acquisition command. When the OID of the command-based history provision command 56 is designated in the status acquisition command (Y in S20), the configuration history provision unit 34 acquires the past configuration command data retrieved according to the preceding command-based history retrieval command 54 and provides the retrieved data to the manager device 14 (S22). Similarly, when the OID of the object-based history provision command 60 is designated in the status acquisition unit (Y in S20), the configuration history provision unit 34 acquires the past object data retrieved according to the preceding object-based history retrieval command 58 and provides the retrieved data to the manager device 14 (S22).

When the OID of a history provision request is not designated in the status acquisition command, namely, when the OID of the management information is designated (N in S20), the information provision unit 32 acquires the current value of the designated management information from the MIB 22 and provides the acquired value to the manager device 14 (S24). When a status acquisition command is not received (N in S18), S20-S24 are skipped.

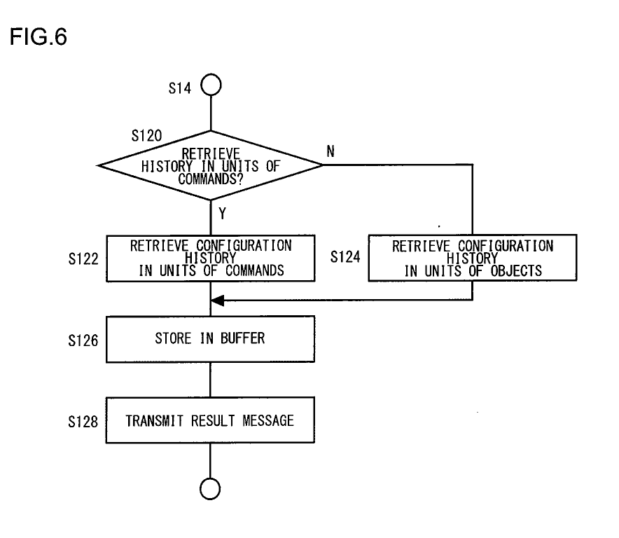

FIG. 6 is a flowchart showing the history retrieval process in S14 of FIG. 5 in further detail. When a history retrieval request comprises the command-based history retrieval command 54 and the parameter value (Y in S120), the configuration processing unit 28 refers to the history table and identifies the past configuration command that goes back from the latest configuration command by the parameter value in the history table (S122). The configuration processing unit 28 stores the identified data in a predetermined buffer (S126). When a history retrieval request comprises the object-based history retrieval command 58 and the parameter value (N in S120), the configuration processing unit 28 identifies the object that goes back from the last object in the latest configuration command by the parameter value in the history table (S124). The configuration processing unit 28 stores the identified data in a predetermined buffer (S126). The result communication unit 30 transmits a result message (getResponse) indicating that the history retrieval process is completed to the manager device 14 (S128).

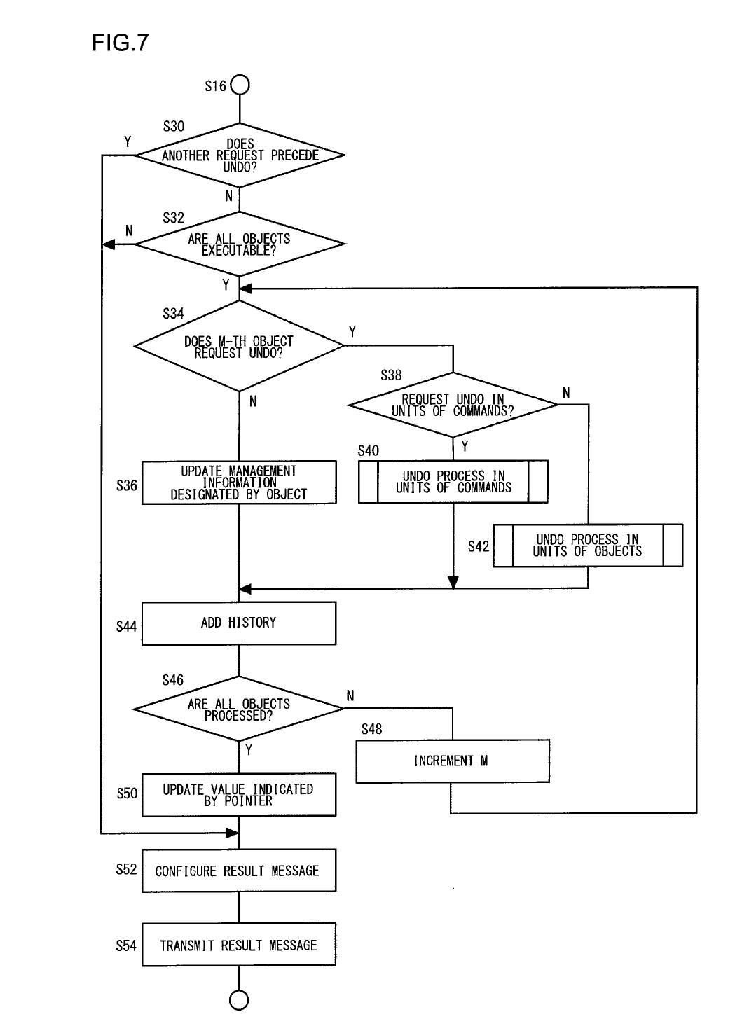

FIG. 7 is a flowchart showing the management information updating process in S16 of FIG. 5 in further detail. The configuration processing unit 28 determines whether the configuration command contains any objects that designate a request other than undo and precede the object that designates undo. More specifically, the configuration processing unit 28 determines whether any object that designated the OID of management information is found before the object that designated the OID of the command-based undo command 50 or the object-based undo command 52. If there is any object found (Y in S30), the configuration processing unit 28 skips the subsequent configuration steps. The configuration processing unit 28 communicates to the result communication unit 30 the object number indicating the position in the configuration command of the object that designates undo immediately following the object that designates a request other than undo. The result communication unit sets getResponse by setting “genErr” in the error status field and setting the object number in the error index field (S52) and transmits the resultant data to the manager device 14 (S54).

A description will be given of why the determination process in S30 is necessary. When a single configuration command includes setting of management information (hereinafter, referred to as “first process”), followed by an undo process, the result of the first process remains even after the past configuration command is undone by the undo process. Undo must be executed prior to setting of management information. It is not desirable that the previously updated management information be undone after the management information is updated. Therefore, the determination process in S30 is performed in order to avoid such a situation.

When the configuration command does not contain any objects that designate a request other than undo and precede the object that designates undo (N in S30), the configuration processing unit 28 determines whether all objects in the configuration command can be executed. For example, the configuration processing unit 28 determines whether the OID designated in the objects is defined in the MIB 22, or whether the range or type of the configuration value meets a predetermined condition. When at least one object cannot be executed (N in S32), the configuration processing unit 28 skips the subsequent configuration steps and communicates the number of object that cannot be executed to the result communication unit 30. The result communication unit 30 sets getResponse by setting a predetermined error type in the error status field and setting the object number in the error index field (S52) and transmits the resultant data to the manager device 14 (S54).

When all objects in the configuration command can be executed (Y in S32), and the M-th object (where the initial value of M is 1) in the configuration command is not an undo request (N in S34), the configuration processing unit 28 updates the management information designated by the object as appropriate (S36). When there are no records having a management number next to the management number pointer value, the configuration processing unit 28 creates a new record. The configuration processing unit 28 records data related to the object in the new record. In this embodiment, the configuration processing unit 28 records the object number (value of M), OID, configuration value, pre-update value (S44). When the M-th object in the configuration command is an undo request (Y in S34) and when the object designates the OID of the command-unit undo command 50 (Y in S38), the configuration processing unit 28 executes a command-based undo process (S40). When the object designates the OID of the object-based undo command 52 (N in S38), the configuration processing unit 28 executes an object-based undo process (S42).

Whichever is the type of undo process, the configuration processing unit 28 appends the data related to the object designating an undo process to the new record (S44). In this case, the OID of the command-based undo command 50 or the object-based undo command 52 is set as the OID. The value mapped to the OID of the command-based undo command 50 or the object-based undo command 52 in the configuration command requesting the undo process is set in the record. In this way, the manager device 14 is capable of determining the number of undos designated in the past undo requests by acquiring a history of configuration commands. “0” is set as the pre-update value.

When there remains any objects not executed (N in S46), M is incremented (S48) and control is returned to S34. When all objects are executed (Y in S46), the configuration processing unit 28 increments the value of the management number pointer. In other words, the configuration processing unit 28 increments the value by 1 so as to create a new record. In addition, the configuration processing unit 28 sets the number of objects in the configuration command, i.e., the object number (value of M) of the last object in the configuration command, in the object number pointer (S50).

Subsequently, the configuration processing unit 28 notifies the result communication unit that the configuration process is completed normally. The result communication unit 30 sets getResponse by setting “noErr” in the error status field and setting “0” in the error index field (S52) and transmits the resultant data to the manager device 14 (S54).

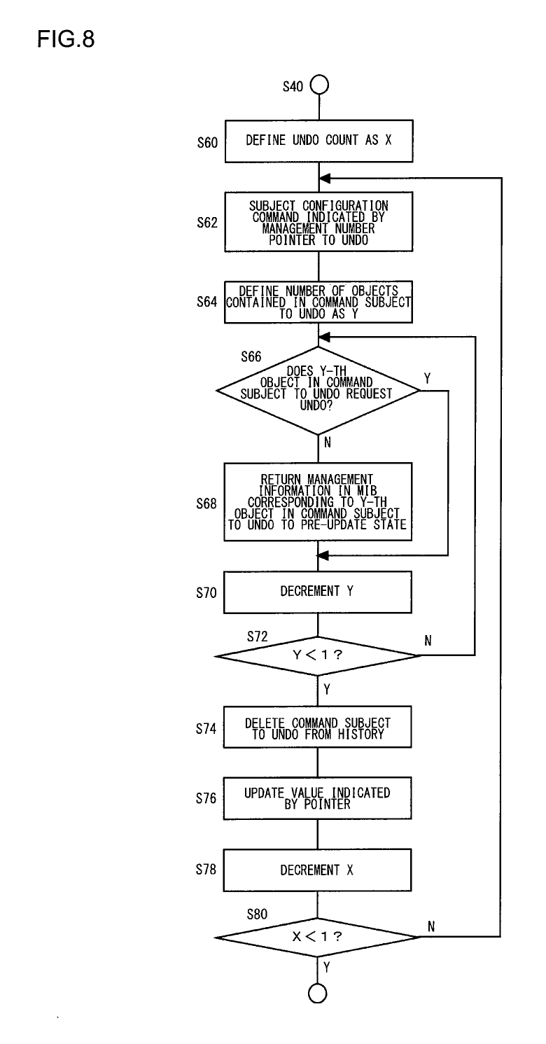

FIG. 8 is a flowchart showing the command-based undo process in S40 of FIG. 7 in further detail. The number of undos designated by the command-based undo command 50 is defined as X (S60). As described above, when the number of undos is not set or 0 is set, the undo count is defined such that X=1. The configuration command indicated by the management number pointer is subject to undo (S62). The number of objects contained in the command subject to undo is defined as Y (S64). Alternatively, the number indicated by the object number pointer may be defined as Y.

The configuration processing unit 28 refers to the history table and determines whether the Y-th object in the command subject to undo (hereinafter, referred to as “object Y”) requests undo, i.e., whether object Y designates the OID of the management information. When object Y does not request undo, i.e., when object Y designates the OID of the management information (N in S66), the configuration processing unit 28 identifies the management information in the MIB 22 corresponding to the OID designated in object Y. The configuration processing unit 28 replaces the current configuration value (updated value) by the pre-updated value maintained in the field for object Y in the history table (S68). When object Y requests undo, i.e., when object Y designated the OID of the command-based undo command 50 or the object-based undo command 52 (Y in S66), S68 is skipped.

Subsequently, the configuration processing unit 28 decrements Y (S70). When Y is still 1 or more (N in S72), control is returned to S66. When Y is less than 1 (Y in S72), the record of the command subject to undo is deleted from the history table (S74). The configuration processing unit 28 decrements the number indicated by the management number pointer and updates the value indicated by the object number pointer by the number of objects (last object number) in the configuration command newly indicated by the management number pointer (S76). The configuration processing unit 28 decrements X (number of undos) (S78). When X is still 1 or more (N in S80), control is turned to S62. When X is less than 1 (Y in S80), the illustrated flow is terminated.

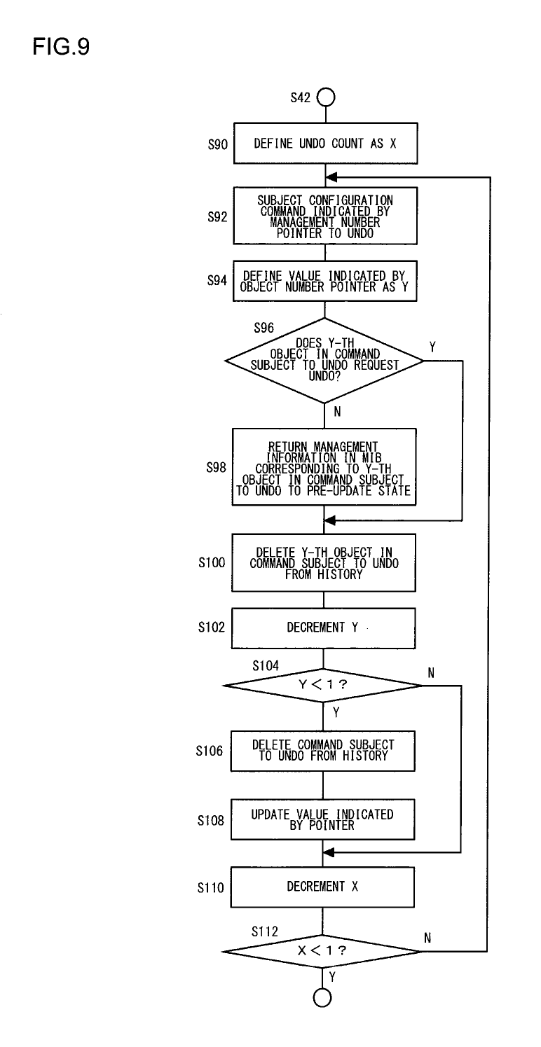

FIG. 9 is a flowchart showing the object-based undo process in S42 of FIG. 7 in further detail. The number of undos designated by the object-based undo command 52 is defined as X (S90). As described above, when the number of undos is not set or 0 is set, the undo count is defined such that X=1. The configuration command indicated by the management number pointer is subject to undo (S92). The number indicated by the object number pointer is defined as Y (S94).

The configuration processing unit 28 refers to the history table and determines whether object Y requests undo. When object Y does not request undo (N in S96), the configuration processing unit 28 identifies the management information in the MIB 22 corresponding to the OID designated in object Y. The configuration processing unit 28 replaces the current configuration value (updated value) by the pre-updated value maintained in the field for object Y in the history table (S98). When object Y requests undo (Y in S96), S98 is skipped. The configuration processing unit 28 deletes object Y subject to undo from the history table (S100) and decrements Y (value indicated by the object number pointer) (S102).

When Y is less than 1 (Y in S104), the configuration processing unit 28 deletes the record of the command subject to undo from the history table (S106). The configuration processing unit 28 further decrements the value indicated by the management number pointer and updates the value indicated by the object number pointer by the number of objects (last object number) in the configuration command newly indicated by the management number pointer (S108). When Y is still 1 or more (N in S104), 5106 and 5108 are skipped. The configuration processing unit 28 decrements X (number of undos) (S110). When X is still 1 or more (N in S112), control is turned to S92. When X is less than 1 (Y in S112), the illustrated flow is terminated.

When the agent device according to the embodiment receives an undo request, the agent device 12 identifies the management information in the MIB 22 updated by the past configuration command by referring to the history table storing the pre-update value and returns the management information in the MIB 22 to the pre-update state. Thus, the maintenance operator desiring to cancel a configuration command issued in the past and return the management information in the MIB 22 to the original state only needs to issue a configuration command designating the OID of the undo command from the manager device 14. This reduces the load on the maintenance operator and reduces the likelihood of a human error.

Further, the maintenance operator can easily designate undo in units of configuration commands, undo in units of objects, and the number of undos, using the agent device 12. In this way, a flexible undo process that matches the intent of the maintenance operator is achieved.

In further accordance with the agent device 12, success or failure of an undo process is communicated to the manager device 14 so that the maintenance operator can easily identify success or failure. For example, it will be assumed that an undo request is issued and, subsequently, the getResponse data in which “genErr” is set in the error status field and the object number is set in the error index is received from the agent device 12. In this case, the maintenance operator can recognize that the undo process failed because the location of the object number in the configuration command is in error and can correct the configuration command efficiently.

Further, the agent device 12 allows the manager device 14 to acquire the content of past configuration commands. This helps the maintenance operator to determine a past configuration command that should be undone and to determine the proper number of undos.

Described above is an explanation based on an exemplary embodiment. The embodiment is intended to be illustrative only and it will be obvious to those skilled in the art that various modifications to constituting elements and processes could be developed and that such modifications are also within the scope of the present invention. A description will now be given of variations.

The first variation will be described. Of those configuration commands subject to undo in undo requests received from the manager device 14, the configuration processing unit 28 may only undo configuration commands received from the manager device 14 originating the undo request. For example, when an undo request is received from the first manager device 14a, the configuration processing unit 28 identifies configuration commands or objects subject to undo from the configuration commands mapped to the IP address of the first manager device 14a in the history table.

Similarly, of those configuration commands indicated as being subject to retrieval in history retrieval requests from a given manager device 14, the configuration processing unit 28 may only retrieve configuration commands received from the manager device originating the history retrieval request. For example, when a history retrieval request is received from the first manager device 14a, the configuration processing unit 28 identifies configuration commands or objects subject to undo from the configuration commands mapped to the IP address of the first manager device 14a in the history table. As a result, the configuration history provision unit 34 provides only those past configuration command data and past object data mapped to the originating device.

In a suitable embodiment of the first variation, the configuration history storage unit 24 may maintain independent history tables, management number pointers, and object number pointers corresponding to respective manager devices 14. For example, the configuration processing unit 28 may store the history of configuration commands received from the first manager device 14a in the history table provided for the first manager device 14a. When the number of undos is designated by the first manager device 14a, the configuration processing unit 28 may refer to the history table provided for the first manager device 14a and identify configuration commands or objects subject to undo.

When the first manager device 14a updates the management information in the agent device 12 and then the second manager device 14b updates the same management information, the subsequent undo request from the first manager device 14a may not result in the management information being restored as desired by the first manager device 14a. According to the first variation, the configuration command issued by the first manager device 14a in the past is undone, triggered by the undo request from the first manager device 14a and the management information is restored to the state occurring when the configuration command was issued. Therefore, undo processes that match the intent of the maintenance operator of each manager device are achieved.

The second variation will be described. In the embodiment described above, the result communication unit 30 provides an error alert indicating a failure in the undo process to the manager device 14, when an undo request is set after another request in a configuration command. In one variation, the result communication unit 30 may receive from the configuration processing unit 28 information related to an error that occurs at various points of time in an undo process if the MIB 22 is not updated successfully in the undo process. The result communication unit 30 may further notifies the manager device 14 that the undo process has failed.

The third variation will be described. In the embodiment described above, configuration commands received from the manager device 14 are sequentially subject to undo in the reverse chronological order. In this case, the configuration value recorded in an object field of a record in the history table referred to by individual undo processes should basically be the same as the current value of the management information. However, the configuration value in the object field may be different from the current value of the management information for some reason. For example, this will occur when the MIB 22 is updated without using a configuration command (e.g., in an emergency response or by unauthorized manipulation). In such a case, it should be desired that restoration of management information through an undo process is avoided and that the incident is reported to the maintenance operator.

This may be achieved by allowing the configuration processing unit 20 to determine whether the current value of the management information matches the configuration value in the object field before rewriting the management information by the pre-update value in an undo process. When the values do not match, the subsequent steps of configuration process may be skipped and the mismatch may be reported to the result communication unit 30. The result communication unit 30 may notify the manager device 40 that the undo process is suspended due to the mismatch.

The fourth variation will be described. The embodiment described above is in compliance with SNMPv1. When a plurality of objects are found in a configuration command and when any of the objects cannot be executed, the configuration processing unit 28 executes none of the objects. The fourth variation is in compliance with SNMPv2c. When a plurality of objects are found in a configuration command and when there is an object that cannot be executed, the other objects are executed.

The fifth variation will be described. The manager device 14 may be provided with means (not referred to in the embodiment) to select the OID automatically in accordance with the type of request sent to the agent device 12 designated by the maintenance operator, and transmit to the agent device 12 a configuration command or a status acquisition command in which the OID is set. Alternatively, the manager device 14 may be provided with means to issue a configuration command including a request to retrieve a history to the agent device 12 when the maintenance operator requests acquisition of information related to a past configuration command, and to automatically issue a status acquisition command, triggered by the reception of a result message from the agent device 12.

Arbitrary combinations of the embodiment and the variations are also useful as embodiments of the present invention. New embodiments produced by combinations will provide the advantages of the embodiments and variations combined.

A skilled person would understand that the functions to be achieved by the constituting elements in the claims are implemented by the constituting elements indicated in the embodiment and the variations on a solitary basis or coordination of the constituting elements.

What is claimed is:

1. An SNMP agent device comprising:
a receiving unit configured to receive an SNMP configuration command from a manager device;
a configuration processing unit configured to update, when the configuration command designates management information and a configuration value, the management information in the agent device by the configuration value; and
a configuration history storage unit configured to store the configuration command, mapping the configuration to a pre-update value of the management information,
wherein, when the configuration command designates undo, the configuration processing unit performs an undo process of returning the management information updated by a past configuration command to the value occurring before the update.

2. The SNMP agent device according to claim 1,
wherein, when a configuration command designates undo in units of configuration commands, the configuration processing unit undos in units of configuration commands, starting with the latest configuration command.

3. The SNMP agent device according to claim 2,
wherein, when the configuration command designates the number of undos in units of configuration commands, the configuration processing unit undos as many recent configuration commands as designated.

4. The SNMP agent device according to claim 1,
wherein, when the configuration command designates a plurality of items of management information and respective configuration values, the configuration processing unit updates the plurality of items of management information in the SNMP agent device by the respective configuration values, and
when the configuration command designates undo in units of management information, the configuration processing unit undos in units of management information, starting with the management information updated last.

5. The SNMP agent device according to claim 4,
wherein, when the configuration command designates the number of undos in units of management information, the configuration processing unit undos as many recent updates of management information as designated.

6. The SNMP agent device according to claim 1,
wherein the configuration history storage unit stores configuration commands received from a plurality of manager devices in a manner that the manager devices originating the commands are distinguishable, and
when a configuration command received from a given manager device designates undo, the configuration processing unit undos the update to the management information by the past configuration command from that manager device.

7. The SNMP agent device according to claim 1, further comprising:
a result communication unit configured to communicate, when an undo process fails, the failure to the manager device in the form of an SNMP response message corresponding to the configuration command.

8. The SNMP agent device according to claim 1, further comprising:
a configuration history provision unit,
wherein the receiving unit is further configured to receive an SNMP status acquisition command from the manager device,
when the status acquisition command indicates a configuration history of management information, the configuration history provision unit provides information related to the past configuration command stored in the configuration history storage unit to the manager device.

9. The SNMP agent device according to claim 8,
wherein the configuration history provision unit provides the pre-update value of the management information updated by the past configuration command, as the information related to the past configuration command.

10. A configuration undo method executed by an SNMP agent device, comprising:
receiving an SNMP configuration command from a manager device;
updating, when the configuration command designates management information and a configuration value, the management information in the agent device by the configuration value;
storing the configuration command, mapping the configuration to a pre-update value of the management information; and
performing, when the configuration command designates undo, an undo process of returning the management information updated by a past configuration command to the value occurring before the update.

11. A computer program embedded in a non-transitory computer-readable recording medium, comprising:
a module configured to receive an SNMP configuration command from a manager device;
a module configured to update, when the configuration command designates management information and a configuration value, the management information in the agent device by the configuration value;
a module configured to store the configuration command, mapping the configuration to a pre-update value of the management information; and
a module configured to perform, when the configuration command designates undo, an undo process of returning the management information updated by a past configuration command to the value occurring before the update.
